(19) United States
(12) Patent Application Publication
(10) Pub. No.: US 2010/0120568 A1
(43) Pub. Date: May 13, 2010

(54) SILENT CHAIN WITH BUSHINGS

(75) Inventor: Toshitaka Ogo, Osaka (JP)

Correspondence Address: HOWSON & HOWSON LLP, 501 OFFICE CENTER DRIVE, SUITE 210, FORT WASHINGTON, PA, 19034, US

(73) Assignee: TSUBAKIMOTO CHAIN CO.,, Osaka (JP)

(21) Appl. No.: 12/557,601

(22) Filed: Sep. 11, 2009

(30) Foreign Application Priority Data
Nov. 7, 2008 (JP) 2008-286804

(51) Int. Cl. F16G 13/04

(52) U.S. Cl. 474/230

(57) ABSTRACT

A silent chain with bushings comprises outer and inner links interconnected in alternating relationship. Each outer link comprises outer plates and connecting pins press-fit into the pin holes in the outer plates. Each inner link comprises a center guide plate disposed at a location midway between the sides of the chain, and toothed inner link plates on both sides of the center guide plate. Bushings are press-fit into bushing holes in the guide plate and the toothed inner link plates. The connecting pins of the outer links extend through bushings of the adjacent inner links, thereby connecting the outer and inner links of the chain are in alternating relationship.

### CROSS-REFERENCE TO RELATED APPLICATION

This application claims priority on the basis of Japanese patent application 2008-286804, filed Nov. 7, 2008. The disclosure of Japanese application 2008-286804 is hereby incorporated by reference.

### FIELD OF THE INVENTION

This invention relates to a silent chain with bushings, for use in the transmission of power, for example as a timing chain in an automobile engine, or as a drive chain in industrial machinery.

### BACKGROUND OF THE INVENTION

Silent chains with bushings have been used to transmit power from a driving sprocket to a driven sprocket. A conventional silent chain with bushings is shown in FIGS. 10, 11 and 12. The silent chain 21 is composed of outer links 25 and inner links 28. The outer links are composed of guide plates 22 arranged on the outermost sides of the chain in the chain width direction, intermediate plates 23 adjacent the insides of the guide plates, and connecting pines 24. The inner links 28 are composed of inner plates 26 and bushings 27. The inner and outer links are in an alternating arrangement in the longitudinal direction of the chain and connected because the connecting pins 24 of the outer links extend through the bushings 27 of the inner links.

As shown in FIG. 11, each of the guide plates 22, on the outermost sides of the chain, has a pair of pin holes 22a, but no sprocket-engaging teeth. As shown in FIG. 12, the intermediate plates 23 have pin holes 23a, and sprocket engaging teeth 23b. In the outer link 25, the guide plate 22 and the intermediate plate 23 are in side-by-side relationship, and the ends of the connecting pins 24 are press-fit into the pin holes 22a and 23a of the guide plates 22 and the intermediate plates 23, respectively.

Each of the inner plates 26 of the inner link 28 has a pair of bushing holes 26a and a pair of engagement teeth 26b, and the both ends of bushings 27 are respectively press-fitted into and secured to a pair of bushing holes 26a of the spaced inner plates 26. That is the bushing 27 are press-fit into bushing holes 26a of the inner plates 26.

In the conventional silent chain with bushings, the outer links 25 and the inner links 28 are alternately arranged in the longitudinal direction of the chain and are articulably connected to one another by inserting the connecting pins 24 of the outer links 25 through the bushings 27 of the inner links 28. The conventional silent chain is described in greater detail in United States Patent Publication 2002/132690.

Because guide plates 23 are provided on both sides of the chain, they occupy space in the direction of the width of the chain corresponding to twice the thickness of a guide plate 23. As a result the overall width W (FIG. 10) of the chain, the space occupied by the chain, and its weight, are all large, and the chain does contribute to the satisfaction of the current demand for size and weight reduction in engines and the like.

The length of the portions of the connection pins 24 that protrude from bushings 27 large. Therefore, flexion of the connecting pins is increased as increasing tension loads are applied to the chain. As a result, problems of excessive wear due to uneven contact between the connecting pins 24 and the bushings 27 occurs, and deformation of the guide plates 22 and the intermediate plates 23 can occur as a result of pin flexion.

In the inner link 28, the inner link plates 26 are press-fit onto both ends of the bushing 27. Significant deformation of the inner surface of the bushing occurs during the press-fitting operation. As a result, contact between the outer circumferential surface of the connecting pin 24 and the inner circumferential surface of the bushing 27 becomes non-uniform and, as a result, increased wear of the outer circumferential surface of the connecting pin 24 and of the inner circumferential surface of the bushing 27 occurs.

An object of the invention is to solve the above-described problems by providing a silent chain with bushings in which significant narrowing of width of the chain and significant weight reduction can be achieved, in which flexion of the connecting pins and deformation of the inner surfaces of the bushings during press-fitting can be suppressed, and wear of the connecting pins and of the bushings can be suppressed.

### SUMMARY OF THE INVENTION

The silent chain according to the invention comprises outer and inner links interconnected in alternating relationship. Each outer link comprises outer plates disposed in opposed, spaced relationship to each other on opposite sides of the chain. These outer plates are the outermost in the direction of the width of the chain, have teeth for engaging teeth of a sprocket. The outer plates also have pin holes. Each outer link also comprises connecting pins press-fit into the pin holes of its outer link plates, and connecting the outer plates. Each inner link comprises a center guide plate disposed at a location midway between the sides of the chain in the direction of the width of the chain, a set of inner plates having teeth for engaging the teeth of a sprocket, and bushings. Each connecting pin of an outer link extends through a bushing of an adjacent inner link, thereby connecting the outer and inner links of the chain are in alternating relationship. In each inner link, the center guide plate has a pair of bushing holes into which the bushings of the inner link are respectively press-fit. In each inner link, inner plates of the inner link are disposed adjacent to, and on both sides of, the center guide plate, and in each inner link, each of the inner link plates has a pair of bushing holes into which the bushings of the inner link are press-fit.

Because the guide plates of the chain are single, centrally located, guide plates instead of pairs of guide plates on opposite sides of the chain, the chain of the invention can be made narrower and lighter in weight than a conventional silent chain. Furthermore, since the connecting pins can be made shorter than the connecting pins of a conventional silent chain, unbalanced contact between the connecting pins and the bushings can be prevented, and wear due to unbalanced contact between the pins and the bushings can be suppressed. For the same reason, deformation of the pins can be reduced.

In addition, since the centers of bushings are press-fit into bushing holes in the central guide plate, less deformation of the inner surfaces of the bushings occurs as the bushings are press-fit into bushing holes of the adjacent inner plates. As a result contact between the outer circumferential surfaces of the connecting pins and the inner circumferential surfaces of the bushings is made more uniform so that wear of the connecting pin and of the bushing is reduced.

In an embodiment in which only one inner plate is provided on each side of center guide plate, the chain can be made much narrower than a conventional chain having similar capabilities. However, by providing two inner plates on each side of the center guide plate, the lengths of the bushings can be increased, and the contact area between the connecting pins and the bushings is correspondingly increased so that the wear of the connecting pins and the bushings can be suppressed, and wear elongation of a chain can be suppressed.

Furthermore, since the center guide plate is press-fit onto the center of the bushing, if the bushing is press-fit into a bushing hole in each of the two inner link plates on each side of the center guide plate, when the bushing is press-fit into the bushing holes of the pairs of inner plates on both sides of the center guide plate uniformity of the shape of the inner surface of the bushing is promoted, so that wear of the connecting pin and of the bushing can be suppressed.

### BRIEF DESCRIPTION OF THE DRAWINGS

FIG. 1 is a plain view of a part of a silent chain with bushings according to the invention;

FIG. 2 is a side elevational view of the part of the silent chain shown in FIG. 1;

FIG. 3A is a front elevational view of an outer plate of the chain;

FIG. 3B is a front elevational view of an inner plate of the chain;

FIG. 3C is a front elevational view of a center guide plate of the chain;

FIG. 4 is a front elevational view of an outer link of the chain;

FIG. 5A is a front elevational view of an inner link of the chain;

FIG. 5B is a cross-sectional view of the inner link;

FIG. 6 is a cross-sectional view showing the engagement of the silent chain with a sprocket;

FIG. 7 is a side elevational view showing the engagement of the silent chain with a sprocket;

FIG. 8 is a plan view showing a part of a silent chain with bushings according to a second embodiment of the invention;

FIG. 9 is a cross-sectional view showing the engagement of the silent chain of FIG. 8 with a sprocket;

FIG. 10 is a plan view, partly in section, of a part of a conventional silent chain with bushings;

FIG. 11 is a side elevational view of the part of the conventional silent chain as shown in FIG. 10; and

FIG. 12 is a cross-sectional view showing the engagement of the conventional silent chain with a sprocket.

### DETAILED DESCRIPTION OF THE PREFERRED EMBODIMENTS

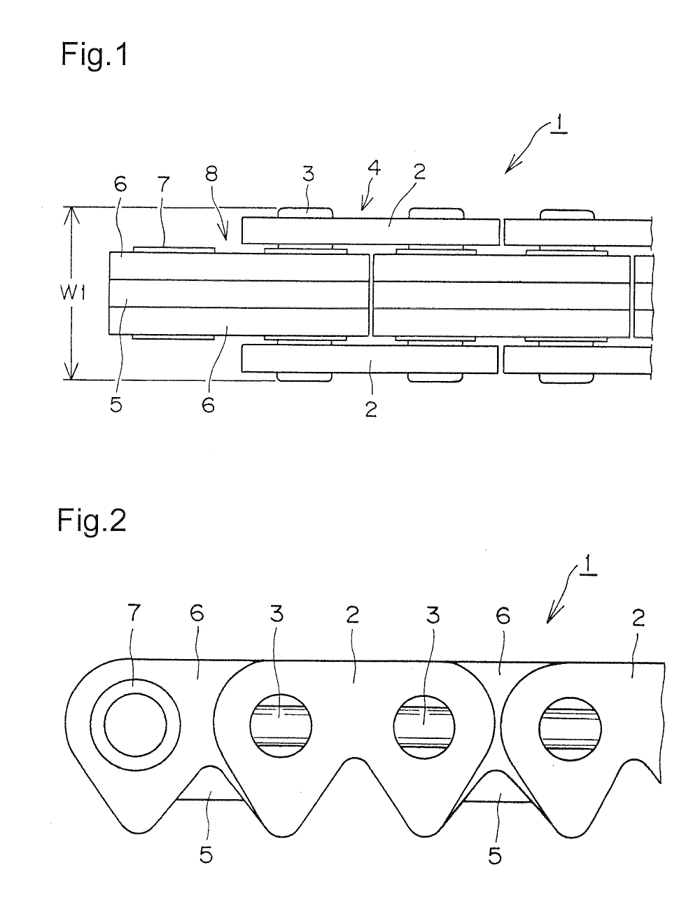

A silent chain 1 according to the invention is shown in FIGS. 1 and 2. An outer link 4 of the chain comprises outer plates 2 arranged on the outermost sides of the chain in the chain width direction and connecting pins 3. An inner link 8 comprises a center guide plate 5 arranged midway between the sides of the chain, inner plates 6, and bushings 7. The outer and inner links are arranged alternately along the longitudinal direction of the chain, and are connected to each other by insertion of the connecting pins 3 through the bushings 7. The outer link 4 is a non=guide row, and the inner link 8 is a non-guide row.

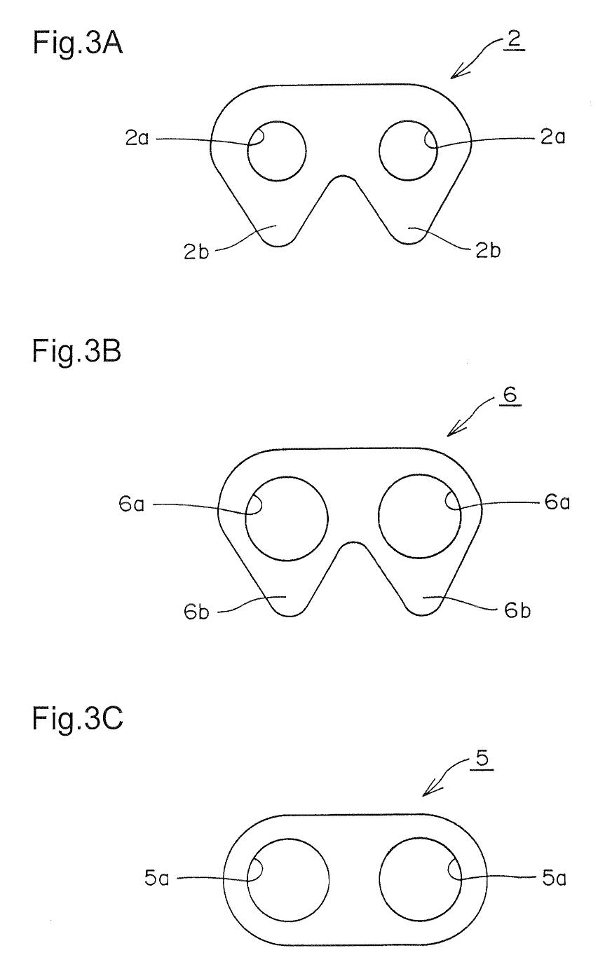

The outer plate 2, as shown in FIG. 3A, has a pair of pin holes 2a and a pair of sprocket tooth engaging teeth 2b. The center guide plate 5 of the link 8 is arranged at the center of the chain in the chain width direction and is formed with has a pair of bushing holes 5a as shown in FIG. 3C, but has no sprocket-engaging teeth. The inner plates 6, as shown in FIG. 3B, which are provided on both sides of the center guide plate 5, have a pair of bushing holes 6a and a pair of engagement teeth 6b.

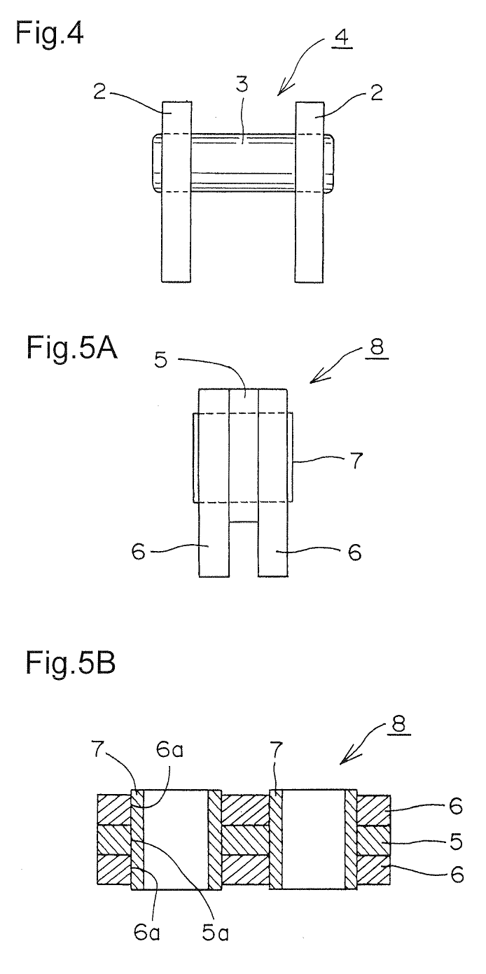

As shown in FIG. 4, the outer link 4 comprised two outer plates 2 in opposed spaced relationship to each other, and connected by two connecting pins 3 press-fit into and secured to pin holes 2a (FIG. 3A). The outer plates 2 are arranged on the sides of a non-guide row of the silent chain 1 so that they are the outermost plates of the chain in the chain width direction. The length of a connecting pin 3 of an outer link 4 becomes the width W1 of the silent chain 1, as shown in FIG. 1.

As shown in FIGS. 5A and 5B, in the inner link 8 bushings 7 are press fit in bushing holes 5a of the center guide plate 5 and guide plate 5 centered on bushing 7 so that it is located midway between the ends of the bushing. Inner plates 6 are located on opposite sides of, and adjacent, the center guide plate 5 and bushings 7 are press-fit into holes 6a of the inner plates.

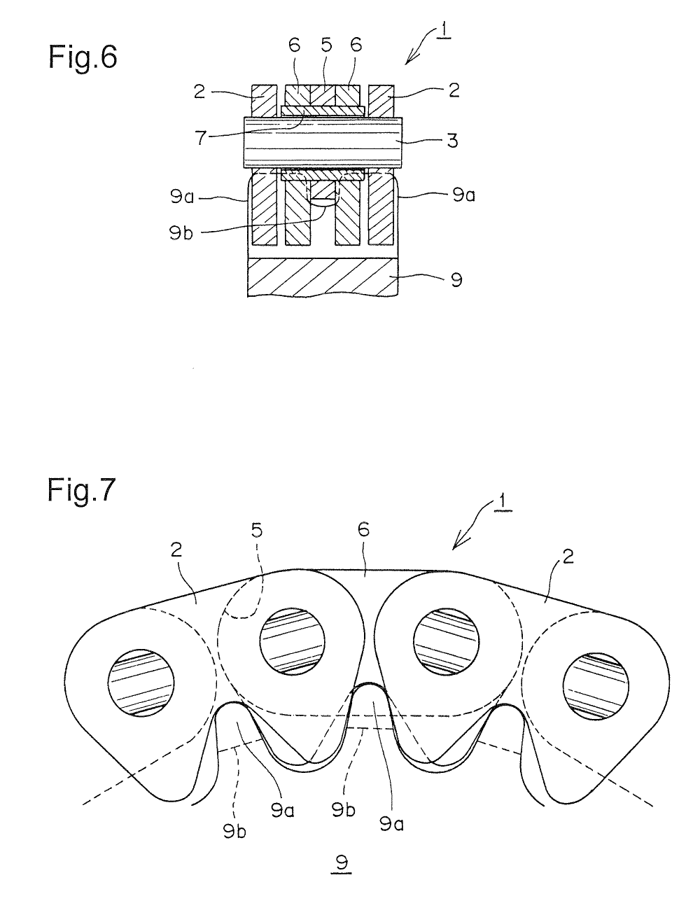

FIGS. 6 and 7 show THE engagement of silent chain 1 with a sprocket 9. The sprocket has a concave groove 9b formed in the middle of each of its teeth 9a, midway between the sides of the sprocket. The teeth 2b of the outer plates 2 and the teeth 6b of the inner plates 6 engage the sprocket teeth 9a, but the center guide plate 5 enters the concave groove 9b. It does not engage the tooth faces of the sprocket teeth 9a in driving relationship, but instead guides the chain, preventing it from moving laterally out of engagement with the sprocket 9 by engagement with the sidewalls of the groove 9b.

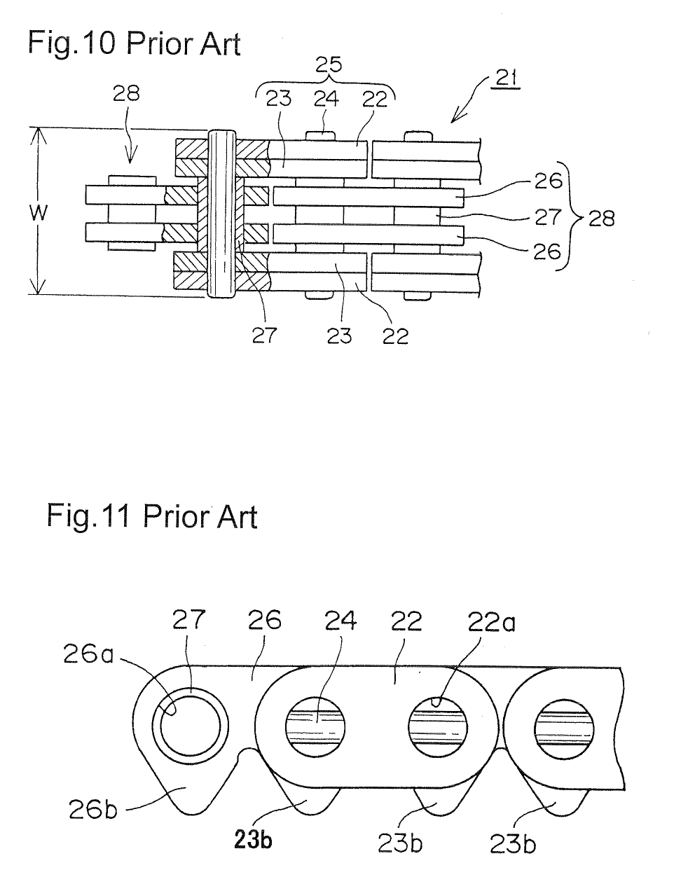

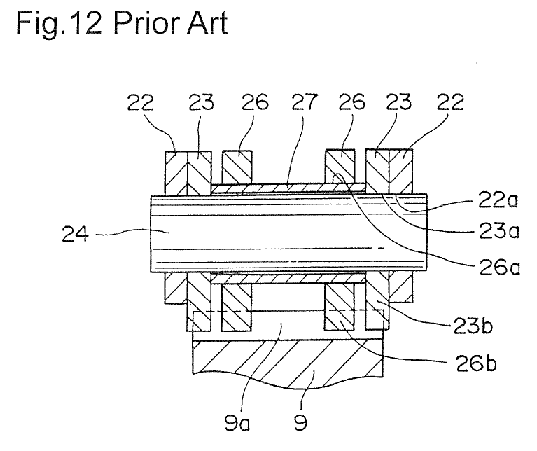

Since the guide plate in each guide row of the chain is only a single central guide plate 5, the width W1 of the chain can be narrower than the width of a conventional silent chain with bushings, which has two guide plates in each guide row, by an amount equal to the width of a guide plate. In other words, whereas the conventional silent chain with bushings has a total of six plates in the widthwise direction as shown in FIG. 10, the silent chain in embodiment of the invention shown in FIGS. 1-7 has a total of only five plates in the widthwise direction, as shown in FIG. 1. Thus, W1<W. As the result the silent chain according to this embodiment of the invention takes up less space, and can be lighter in weight, than a conventional silent chain with bushings. In addition, because the chain according to the invention has one guide plate in the widthwise direction instead of two, and the overall width of the chain is reduced by the thickness of one guide plate, the connecting pins can be shortened by the same amount. Pin flexion resulting from chain tension is therefore suppressed, and wear of the connecting pin 3 and of the bushing 7 due to non-uniform contact between them is also suppressed. In addition, since pin flexion is suppressed, deformation of the outer plates 2 resulting from pin flexion can also be prevented.

In the inner link 8, the bushings 7 are press-fit into the respective bushing holes 5a of the central guide plate 5. When bushings 7 are press-fit into bushing holes 6b of the adjacent inner plates 6, expansion of the outer diameter of the bushing 7 is limited by the center guide plate 5, and consequently deformation of the inner surface of the bushing 7 is reduced. As a result, the contact between the outer circumferential surface of the connecting pin 3 and the inner circumferential surface of the bushing 7 is more uniform, and wear of the connecting pin 3 and the bushing 7 is accordingly reduced.

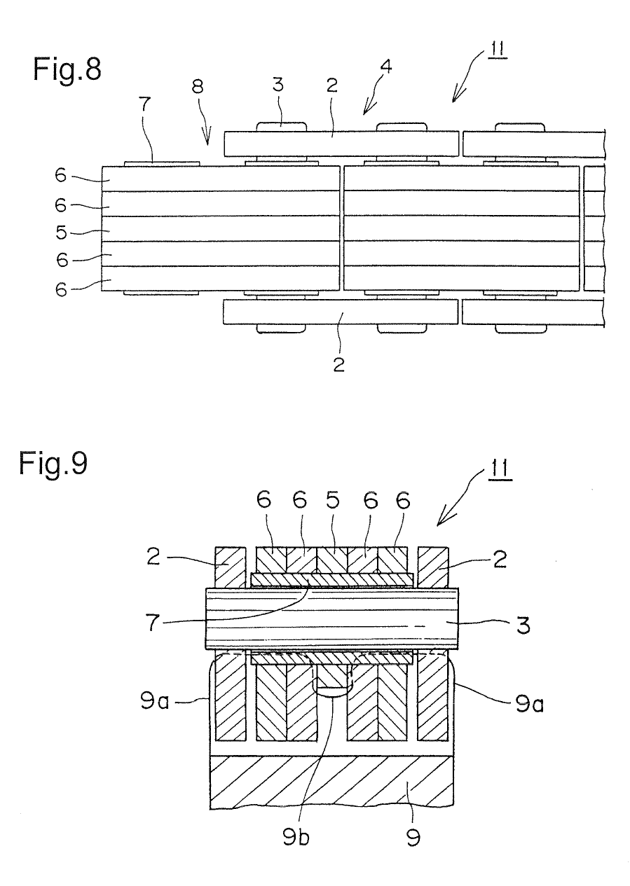

A second embodiment of the invention is shown in FIGS. 8 and 9, in which a silent chain 11 corresponds to silent chain 1 described above, except that double inner plates 6 are provided in place of the single inner plates on both sides of the center guide plate 5.

With two inner plates 6 on each sides of the center guide plate 5, the length of the bushing 7 can be increased. As a result, the contact area between the connecting pins 3 and the bushings 7 is increased, so that wear elongation of the chain is suppressed. As in the first embodiment, bushings 7 are press-fit into bushing holes in the center guide plate 5, and into bushing holes 6a of at least the inner plates 6 immediately adjacent the center guide plate on both sides thereof. Preferably, the bushings are press fit into both of the inner link plates on each side of the center guide plate. Press-fitting of the bushings into the center guide plate decreases deformation of the inner surface of the bushing when it is press-fit into the inner plates 6, and consequently wear of the connecting pins 3 and the bushings 7 is suppressed.

What is claimed is:

1. A silent chain comprising outer and inner links, wherein:
each outer link comprises outer plates disposed in opposed, spaced relationship to each other on opposite sides of the chain, said outer plates being the outermost in the direction of the width of the chain, and said outer plates having teeth for engaging teeth of a sprocket and also having pin holes, and said outer link also comprising connecting pins press-fit into said pin holes and connecting its outer plates;
each inner link comprises a center guide plate disposed at a location midway between the sides of the chain in the direction of the width of the chain, a set of inner plates having teeth for engaging the teeth of a sprocket, and bushings;
said each said connecting pin of an outer link extends through a bushing of an adjacent inner link, whereby the outer and inner links of the chain are connected in alternating relationship;
in each said inner link, the center guide plate has a pair of bushing holes into which the bushings of the inner link are respectively press-fit;
in each said inner link, inner plates of the inner link are disposed adjacent to, and on both sides of, said center guide plate; and
in each said inner link, each of said inner link plates has a pair of bushing holes into which the bushings of said inner link are press-fit.

2. A silent chain according to claim 1, in which, in each said inner link, only one inner plate is provided on each side of center guide plate.

3. A silent chain according to claim 1, in which, in each said inner link, two inner plates are provided on each side of the center guide plate.

4. A silent chain according to claim 1, in which, in each said inner link, two inner plates are provided on each side of the center guide plate, each of said inner plates has bushing holes, and each bushing of said inner link is press-fit into a bushing hole of each of said two inner link plates on each side of the center guide plate.
